(19) United States
(12) Patent Application Publication
(10) Pub. No.: US 2011/0180964 A1
(43) Pub. Date: Jul. 28, 2011

(54) SYSTEMS AND METHODS FOR SUBSTRATE FORMATION

(75) Inventor: Byung-Jin Choi, Austin, TX (US)

(73) Assignee: MOLECULAR IMPRINTS. INC., Austin, TX (US)

(21) Appl. No.: 12/987,196

(22) Filed: Jan. 10, 2011

Related U.S. Application Data
(60) Provisional application No. 61/298,794, filed on Jan. 27, 2010.

(51) Int. Cl. B29C 59/02

(52) U.S. Cl. 264/293; 425/385

(57) ABSTRACT

Templates for patterning large area substrates are provided. Generally, templates include a body and a plurality of molds positioned on the body. Each mold has a first length and each mold may be separated by an open space having a distance therebetween. The length of the mold may be substantially similar to the distance between the open space or the length of the mold may be substantially greater than the distance between the open space. Additionally, purging techniques that incorporate features of the template are described.

### CROSS-REFERENCE TO RELATED PATENT APPLICATIONS

The present application claims priority to U.S. Ser. No. 61/298,794, filed Jan. 27, 2010, which is hereby incorporated by reference in its entirety.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate; therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference herein.

An imprint lithography technique disclosed in each of the aforementioned U.S. patent publications and patent includes formation of a relief pattern in a formable (polymerizable) layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that features and advantages of the present invention can be understood in detail, a more particular description of embodiments of the invention may be had by reference to the embodiments illustrated in the appended drawings. It is to be noted, however, that the appended drawings only illustrate typical embodiments of the invention, and are therefore not to be considered limiting of its scope, for the invention may admit to other equally effective embodiments.

FIG. 1 illustrates a simplified side view of a lithographic system.

FIG. 2 illustrates a simplified side view of the substrate illustrated in FIG. 1, having a patterned layer thereon.

FIGS. 3-5 Illustrate simplified side views of an exemplary imprinting system in accordance with the present invention.

FIGS. 6A and 6B illustrate top down views of exemplary templates for use with imprinting system of FIGS. 3-5.

FIG. 7 illustrates a simplified side view of another exemplary template for use with imprinting system of FIGS. 3-5.

FIG. 8 illustrates a top down view of the template illustrated in FIG. 7.

FIG. 9 illustrates a simplified side view of an exemplary gas purging system for use in templates illustrated in FIGS. 3-8.

### DETAILED DESCRIPTION

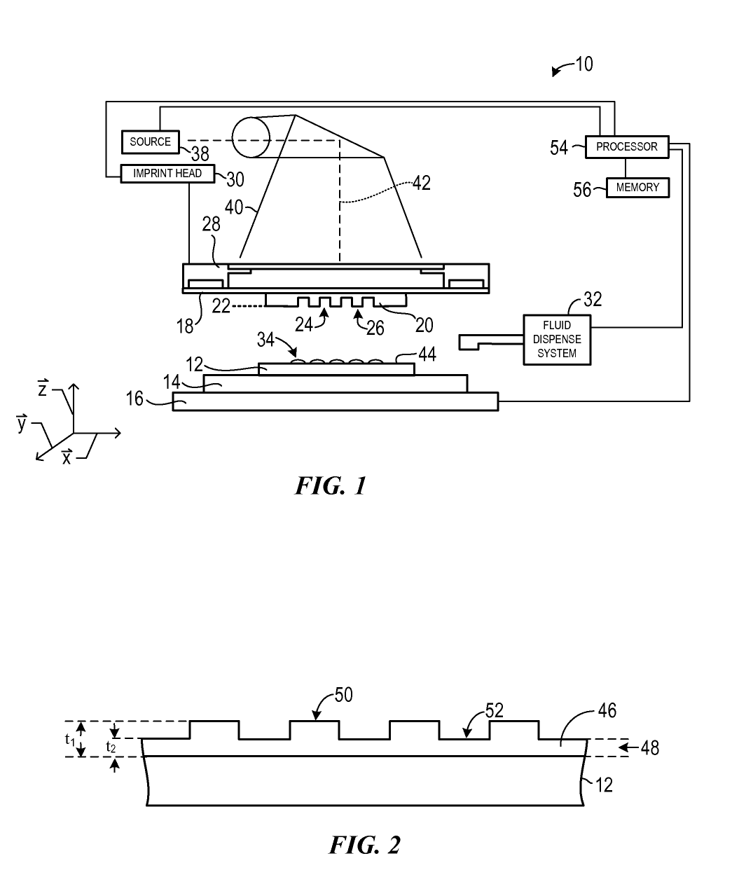

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electrostatic, electromagnetic, and/or the like. Exemplary chucks are described in U.S. Pat. No. 6,873,087, which is hereby incorporated by reference herein.

Substrate 12 and substrate chuck 14 may be further supported by stage 16. Stage 16 may provide translational and/or rotational motion along the x, y, and z-axes. Stage 16, substrate 12, and substrate chuck 14 may also be positioned on a base (not shown).

Spaced-apart from substrate 12 is template 18. Template 18 may include a body having a first side and a second side with one side having a mesa 20 extending therefrom towards substrate 12. Mesa 20 having a patterning surface 22 thereon. Further, mesa 20 may be referred to as mold 20. Alternatively, template 18 may be formed without mesa 20.

Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations (e.g., planar surface). Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electrostatic, electromagnetic, and/or other similar chuck types. Exemplary chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit formable material 34 (e.g., polymerizable material) on substrate 12. Formable material 34 may be positioned upon substrate 12 using techniques, such as, drop dispense, spin-coating, dip coating, chemical vapor deposition (CVD), physical vapor deposition (PVD), thin film deposition, thick film deposition, and/or the like. Formable material 34 may be disposed upon substrate 12 before and/or after a desired volume is defined between mold 22 and substrate 12 depending on design considerations. Formable material 34 may be functional nano-particles having use within the bio-domain, solar cell industry, battery industry, and/or other industries requiring a functional nano-particle. For example, formable material 34 may comprise a monomer mixture as described in U.S. Pat. No. 7,157,036 and U.S. Patent Publication No. 2005/0187339, both of which are herein incorporated by reference. Alternatively, formable material 34 may include, but is not limited to, biomaterials (e.g., PEG), solar cell materials (e.g., N-type, P-type materials), and/or the like.

Referring to FIGS. 1 and 2, system 10 may further comprise energy source 38 coupled to direct energy 40 along path 42. Imprint head 30 and stage 16 may be configured to position template 18 and substrate 12 in superimposition with path 42. System 10 may be regulated by processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by formable material 34. For example, imprint head 30 may apply a force to template 18 such that mold 20 contacts formable material 34. After the desired volume is filled with formable material 34, source 38 produces energy 40, e.g., ultraviolet radiation, causing formable material 34 to solidify and/or cross-link conforming to a shape of surface 44 of substrate 12 and patterning surface 22, defining patterned layer 46 on substrate 12. Patterned layer 46 may comprise a residual layer 48 and a plurality of features shown as protrusions 50 and recessions 52, with protrusions 50 having a thickness t₁ and residual layer having a thickness t₂.

The above-mentioned system and process may be further employed in imprint lithography processes and systems referred to in U.S. Pat. No. 6,932,934, U.S. Pat. No. 7,077,992, U.S. Pat. No. 7,179,396, and U.S. Pat. No. 7,396,475, all of which are hereby incorporated by reference in their entirety.

### Shape Modulation

During imprinting, as the distance between mold 20 and substrate is reduced, it may be necessary to substantially remove air voids to eliminate defects. Air void elimination may be enhanced by modulating the shape of mold 20 and/or substrate 12. For example, by modulating the shape of mold 20 and/or substrate 12, gas may be pushed out from between mold 20 and substrate 12 by providing an optimal curvature at the fluid spreading front.

When imprinting a relatively small field size (e.g., up to 6 inches), single wave shape modulation is generally used for nano-imprinting and contact printing. As field size grows, however, single-wave modulation requires deflection of mold 20 and/or substrate 12 to increase rapidly in order to provide local curvature (e.g., 4^{th} order of the size). Further, single wave modulation on a large field size may result in slow throughout, in-balanced spread time across the field, and/or a requirement of a large reaction force (e.g., 10 Kpa over 0.5 m square having 2500 N reaction force).

Shape modulation for large field sizes generally needs to provide a controlled and fast fluid spreading modulation, perform efficient gas purging, and/or provide sufficient fluid filling time. Systems and methods described herein provide for shape modulation and gas purging for large field sizes providing for such elements.

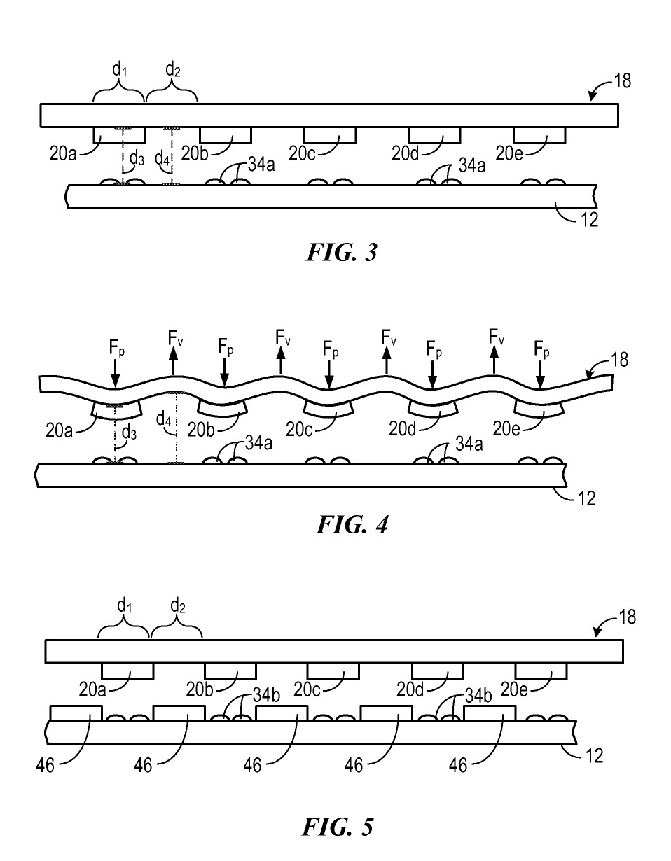

FIGS. 3-5 illustrate exemplary imprinting systems for imprinting over a large field size. In particular, FIGS. 3-5 illustrate a multi-wave modulation scheme for simultaneously patterning distinct areas of a field of substrate 12. As illustrated herein, the multi-wave modulation scheme varies the shape of template 18 and/or molds 20. It should be noted, however, substrate 12 may also be provided in a multi-wave modulation scheme as described herein.

Generally, template 18 may include several molds 20 separated by open spaces. Molds 20a-20e illustrated are exemplary as template 18 may include any number of molds 20 depending on design considerations. Template 18 may include molds 20 having a length d₁ with each mold separated by an open space having a distance d₂.

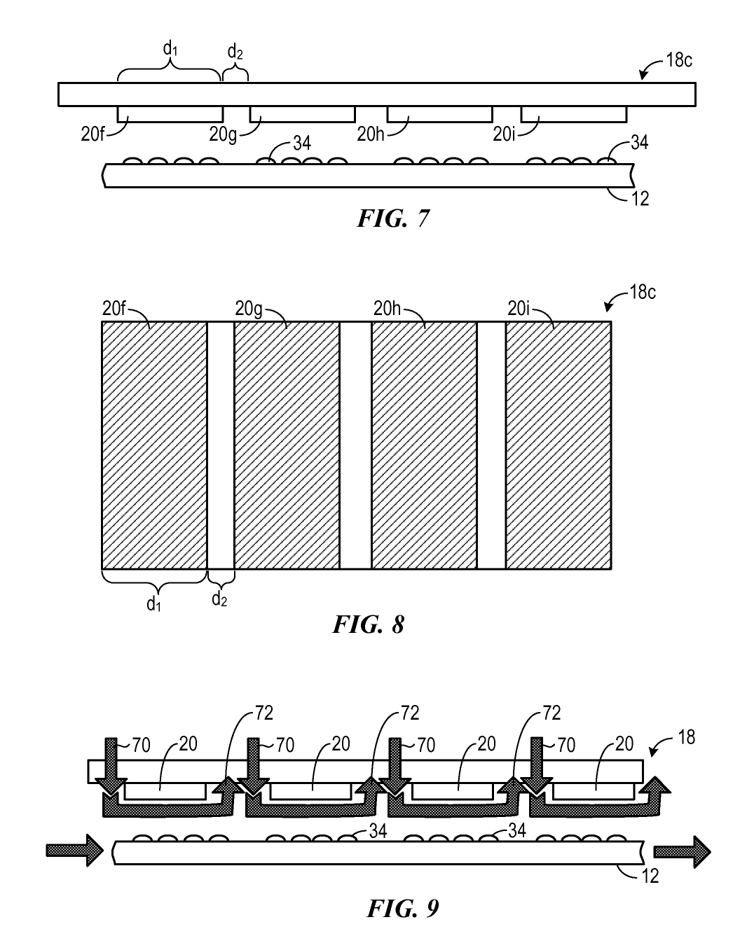

FIGS. 7 and 8 illustrate one embodiment, wherein distance d₂ between molds 20 may be minimal and substantially less than length d₁ of molds 20. For example, distance d₂ of open space between molds 20 of template 18 may be less than or substantially equal to 5% of the total area of template 18. With a minimal distance d₂ between molds 20, only a small loss of patterned areas between molds 20 will result during imprinting of substrate 12 using template 18 as described in relation to FIGS. 3-5.

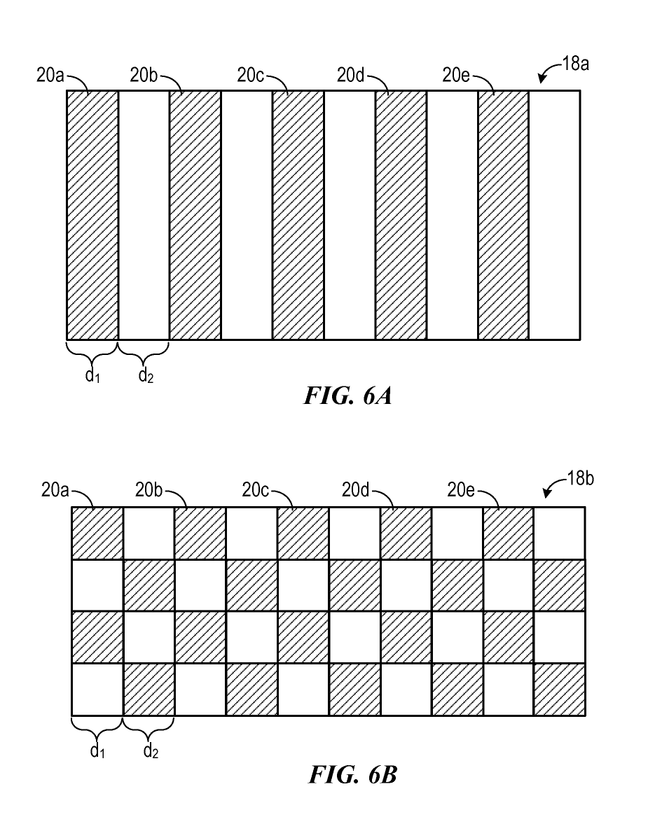

In another embodiment, length d₁ of molds 20 may be substantially similar to distance d₂ between molds 20. FIG. 3 illustrates template 18 having magnitudes of length d₁ of molds 20 and distance d₂ between molds 20 that are substantially similar. Template 18 may be constructed such that molds 20 provide for approximately one-half of the imprinting field of substrate 12. An imprinting field may be the entire area of substrate 12, or imprinting field may be one of multiple distinct imprinting areas of substrate 12. FIGS. 6A and 6B illustrate exemplary templates 18a and 18b having molds 20 providing for approximately one-half of imprinting field of substrate 12 in accordance with the present invention. FIG. 6A provides for template 18a having a striped configuration wherein length d₁ of molds 20 are substantially similar to distance d₂ between molds 20. FIG. 6B provides for template 18b having a checkerboard configuration. Similar to FIG. 6A, distance between molds 20 is substantially similar to distance d₂ between molds 20.

During imprinting of substrate 12, template 18 may be in superimposition with the entire field of substrate 12; however, only a portion (e.g., one-half) of field of substrate 12 may be patterned at a time. With molds 20 that correspond to approximately one-half of imprinting field of substrate 12 (e.g., FIGS. 6A and 6B), template 18 may imprint a field of substrate 12 using a “two-step” step and repeat method. In a “two-step” step and repeat method, template 18 may imprint a first half of a field of substrate 12 with molds 20 providing multiple patterned layers 46 (shown in FIG. 2) separated by open areas on substrate 12. Distance between open areas of substrate 12 may correspond to distance d₂ between molds 20 of template 18. Template 18 may then imprint the second half of the field. In imprinting the second half of the field, molds 20 may pattern the open areas (i.e., unpatterned areas) of substrate 12 between patterned layers 46 formed by imprinting of the first half of substrate 12.

FIGS. 4 and 5 illustrate exemplary shape modulation of template 18 and/or mold 20 for imprinting only a portion of polymerizable material 34 on a field of substrate 12. Shape modulation of template 18 and/or molds 20 may provide for only a portion of field to be imprinted.

Polymerizable material 34 may be deposited on substrate 12 such that patterned layers 46 may only be formed in areas in superimposition with molds 20 as illustrated in FIG. 5. Alternatively, polymerizable material 34 may be deposited on the entire field of substrate 12. Shape of template 18 and/or molds 20 may be altered such that a distance d₃ defined between molds 20 and substrate 12 at center sub-portion of molds 20 is less than distance d₄ defined between molds 20 and substrate 12 at remaining portions of molds 20.

The shape of template 18 and/or molds 20 may be altered by controlling pressure applied to template 18. For example, a pump system may operate to control pressure directly to template 18 or to chuck 28 (shown in FIG. 1). The pump system may create vacuum pressure F_{V} at portions of template 18 between molds 20. An exemplary system using bowing to reduce distance d₃ between a mold and a substrate is further described in U.S. Patent Publication No. 2007/0114686, which is hereby incorporated by reference in its entirety.

Vacuum pressure F_{V} at portions of template 18 between molds 20 may result in multiple portions of template 18 bowing away from substrate 12 increasing or stabilizing d₄, as remaining portions of template 18 bow towards substrate 12 decreasing distance d₃. Such bowing provides for multiple simultaneous wave formations in template 18 and/or molds 20. The multiple simultaneous wave formations provide for simultaneous imprinting/patterning of portions of a field, with the patterned portions separated by open areas (i.e., unpatterned areas).

Optionally, the pump system may provide an increase in pressure F_{P} at portions of template 18 having mold 20. Such an increase may further reduce distance d₃ and/or increase distance d₄. Typically, for a thickness of ˜600 μm fused silica template, pressure can be in the range of 5-15 Kpa.

### Gas Purging

When imprinting small fields (e.g., up to 6 inches), gas purging may be performed by arrangement of nozzles at a boundary of template 18 and/or substrate 12 (e.g., outside of mold area). For large fields, however, arrangement of nozzles at a boundary of template 18 and/or substrate 12 does not provide adequate performance for efficient gas purging. This scheme may take excessively long and local areas between template 18 and substrate 12 may suffer from fluid evaporation.

In one embodiment, purging ports 70 and/or venting channels 72 may be provided in the design of templates 18 provided herein. Purging ports 70 may be positioned between molds 20 and at edges of template 18. For example, purging ports 70 may be throughways positioned in open space between molds 20 of template 18 and at edges of template 18. Purging ports 70 may be in fluid communication with a pump system providing gas thereto (e.g., helium, hydrogen, nitrogen, carbon dioxide, and the like).

Optionally, venting channels 72 may be positioned between molds 20 and/or at edges of template 18. Similar to purging ports 70, venting channels 72 may be throughways positioned in open spaces between molds 20. The number of venting channels 72 may be substantially similar or different from purging ports 72. Venting channels 72 may be in fluid communication with a vacuum system or in fluid communication with atmospheric air for disposal of gas.

Purging ports 70 may provide a flow of gas (e.g., helium, hydrogen, nitrogen, carbon dioxide, and the like) between template 18 and substrate 12. The flow of gas may exit from between template 18 and substrate 12 via venting channels 72. Alternatively, the flow of gas may exit at edges of template 18. Movement of substrate chuck 16 (shown in FIG. 1) to position field of substrate 12 in superimposition with template 18 may aid in directing flow of gas from purging port 70 to venting channel 72 as illustrated in FIG. 9 and/or directing flow of gas from purging port 70 to edges of template 18. For example, each mold 20 may have a first side and a second side with at least one purging port 70 positioned on the first side and at least one venting channel 72 positioned on the second side. Positioning of substrate 12 may aid in directing flow of gas from purging port 70 on first side of each mold 20 to between mold 20 and substrate 12 and further to venting channel 72 positioned on second side of mold 20.

In another embodiment, multiple templates 18 having individual molds 20 may be used to simultaneously pattern a portion of substrate 12. In using multiple templates 18, a single chuck, (e.g., chuck 28 shown in FIG. 1) may hold each template 18 during imprinting and the area of the chuck between templates 18 may provide for purging and/or venting channels.

### Removal of Residual Layer

Subsequent to imprinting, patterned layers 46 formed on substrate 12 may be etched removing at least a portion of residual layer 48. During the imprinting process, as described above, the distance between template 18 and substrate 12 is reduced and polymerizable material 34 flows to conform to topography of template 18 and substrate 12. When template 18 and substrate are within a minimal distance of one another, the flow channel between them may be very narrow reducing flow of polymerizable material 34. Techniques may be implemented to increase the flow rate. For example, polymerizable material 34 may include the use of low viscosity materials (e.g., materials having a viscosity less than approximately 10 centipoise). By using low viscosity material the flow channel between template 18 and substrate 12 may be 25 nm or smaller.

Thickness of the flow channel directly forms residual layer 48 (shown in FIG. 2). As such, residual layer 48 generally includes a non-zero thickness t₂. Many applications, however, provide for the removal of residual layer 48 from patterned layer 46 such that substrate 12 may be accessible between features 50 and 52.

The most common method for removing residual layer 48 from patterned layer 46 includes a plasma-based etching process. Such processes may be capable of directional (i.e., primarily vertical) etching of solidified polymerizable material 34, such that residual layer 48 may be removed with minimal alterations to the lateral dimensions of features 50 and 52.

Alternatively, vacuum ultraviolet radiation may be used to remove solidified polymerizable material 34. A radiation source may comprise a range of approximately 140 nm to 190 nm wavelength. In one embodiment, radiation may be provided by a Xe excimer dielectric barrier discharge lamp. The lamp may have peak intensity at a wavelength of approximately 172 nm, with a spectral bandwidth of approximately 15 nm FWHM. Intensity of radiation at the surface of residual layer 48 is approximately 5 to 150 mW/cm². Further, radiation source may be enclosed within a chamber. A composition of gas may be present inside the chamber. For example, the composition of gas may consist of at least 95 percent nitrogen and less than 5 percent oxygen.

Subsequent to imprinting of patterned layer 46, substrate 12 may be positioned in alignment with radiation source (VUV). Radiation (e.g., VUV radiation) may be provided to patterned layer 46. For example, vacuum ultraviolet radiation with peak intensity of approximately 172 nm, having a spectral bandwidth of approximately 15 nm FWHM may be provided to patterned layer 46. Additionally, increasing the air environment to provide approximately 98% nitrogen and less than 2% oxygen may substantially increase the quality of the pattern enabling removal of residual layer 48 while substantially preserving desired structures. Systems and methods providing for VUV radiation are further described in U.S. Ser. No. 61/298,734 filed Jan. 27, 2010.

What is claimed is:

1. A system, comprising:
a template comprising:
a body having a first surface and a second surface; and,
a plurality of molds positioned on the second surface, each mold having a first length (d₁) and each mold separated by an open space having a distance (d₂), wherein d₁ is substantially similar to d₂.

2. The system of claim 1, further comprising:
a substrate in superimposition with the template, the substrate having a plurality of imprinting fields wherein each mold of the template provides for one half of an imprinting field.

3. The system of claim 1, wherein the molds are configured in a striped configuration.

4. The system of claim 1, wherein the molds are configured in a checkerboard configuration.

5. The system of claim 1, wherein the body includes at least one purging port.

6. The system of claim 1, wherein the body includes at least one venting channel.

7. A system, comprising:
a template comprising:
a body having a first surface and a second surface; and,
a plurality of molds positioned on the second surface, each mold having a first length (d₁) and each mold separated by an open space having a distance (d₂), wherein d₁ is substantially greater than d₁.

8. The system of claim 7, wherein the distance (d₂) of the open space between each mold is less than 5% total area of the body.

9. The system of claim 7, wherein the distance (d₂) of the open space between each mold is substantially equal to 5% total area of the body.

10. The system of claim 7, wherein the molds are configured in a striped configuration.

11. The system of claim 7, wherein the molds are configured in a checkerboard configuration.

12. The system of claim 7, wherein the body includes at least one purging port.

13. The system of claim 7, wherein the body includes at least one venting channel.

14. A method for purging gas between a template and a substrate, comprising;
positioning the template in superimposition with the substrate, the template having a plurality of molds separated by a plurality of open spaces, each mold having a first side and a second side with a purging port positioned in an open space adjacent to the first side of the mold and an associated venting channel positioned in an open space adjacent to the second side of the mold;
providing a flow of gas through at least one purging port, the flow of gas directed between the template and the substrate and exiting through the associated venting channel.

15. The method of claim 14, wherein at least a portion of the flow of gas exits at an edge of the template.
